(19) United States
(12) Patent Application Publication
(10) Pub. No.: US 2022/0367080 A1
(43) Pub. Date: Nov. 17, 2022

(54) STORING HAZARDOUS WASTE MATERIAL

(71) Applicant: Deep Isolation, Inc., Berkeley, CA (US)

(72) Inventors: Richard A. Muller, Berkeley, CA (US); Elizabeth Muller, Berkeley, CA (US)

(21) Appl. No.: 17/767,224

(22) PCT Filed: Apr. 7, 2020
(86) PCT No.: PCT/US2020/054614

§ 371 Date: Apr. 7, 2022

Related U.S. Application Data
(60) Provisional application No. 62/911,553, filed on Oct. 7, 2019.
(60) Provisional application No. 62/911,547, filed on Oct. 7, 2019.
(60) Provisional application No. 62/911,614, filed on Oct. 7, 2019.
(60) Provisional application No. 62/930,320, filed on Nov. 4, 2019.

(51) Int. Cl. G21F 9/24; G21F 9/34; G21F 5/14

(52) U.S. Cl. CPC G21F 9/24; G21F 9/34; G21F 5/14

(57) ABSTRACT

A nuclear waste storage system includes a human-unoccupiable directional drillhole formed from a terranean surface into a subterranean formation, the drillhole including a substantially vertical portion and a substantially horizontal portion that includes a hazardous waste repository for nuclear waste storage; a casing including one or more tubular sections sized to fit within the drillhole; and a coating attached to an exterior surface of the casing, the exterior surface facing a rock formation through which the drillhole is formed.

### TECHNICAL FIELD

This disclosure relates to storing hazardous waste material and, more particularly, storing hazardous waste material in a canister emplaced in a hazardous waste repository formed in a drillhole within a subterranean formation.

### BACKGROUND

Hazardous material, such as radioactive waste, is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even high-grade military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels, and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In a general implementation, a method for storing nuclear waste includes positioning a casing at an entry of a human-unoccupiable directional drillhole formed from a terranean surface to a subterranean formation. The casing includes a coating attached to an exterior surface of the casing. The casing includes one or more tubular sections sized to fit within the human-unoccupiable directional drillhole. The drillhole includes a substantially vertical portion and a substantially horizontal portion that includes a hazardous waste repository for nuclear waste storage. The method further includes inserting the casing into the drillhole such that the exterior surface of the casing faces a rock formation through which the drillhole is formed; moving a nuclear waste canister into the drillhole through the casing, the nuclear waste canister configured to hold nuclear waste; and storing the nuclear waste canister in the hazardous waste repository.

In an aspect combinable with the example implementation, the casing includes carbon-steel.

In another aspect combinable with any of the previous aspects, the coating includes a corrosion-resistant and scratch-resistant coating.

In another aspect combinable with any of the previous aspects, the coating includes at least one of quartz, diamond-like carbon (DLC), hard chrome, high velocity oxygen fuel (HVOF), Hardide®, or other glasses.

Another aspect combinable with any of the previous aspects further includes attaching another coating to an interior surface of the casing.

In another aspect combinable with any of the previous aspects, the another coating includes at least one of a corrosion resistant alloy (CRA) or stainless steel.

In another aspect combinable with any of the previous aspects, the another coating includes a corrosion-resistant and scratch-resistant coating.

In another aspect combinable with any of the previous aspects, the another coating includes at least one of quartz or DLC.

In another aspect combinable with any of the previous aspects, the nuclear waste canister is configured to be retrievable from the drillhole at any time within a period of time.

In another aspect combinable with any of the previous aspects, the period of time is set as an industry requirement in order to use the drillhole as an interim storage facility.

In another aspect combinable with any of the previous aspects, the period of time ranges from a few years to up to 50 years.

Another aspect combinable with any of the previous aspects further includes sealing the substantially vertical portion of the drillhole to transform the hazardous waste repository into a permanent hazardous waste repository.

In another example implementation, a nuclear waste storage system includes a human-unoccupiable directional drillhole formed from a terranean surface into a subterranean formation, the drillhole including a substantially vertical portion and a substantially horizontal portion that includes a hazardous waste repository for nuclear waste storage; a casing including one or more tubular sections sized to fit within the drillhole; and a coating attached to an exterior surface of the casing, the exterior surface facing a rock surface of the subterranean formation through which the drillhole is formed.

An aspect combinable with the example implementation further includes a nuclear waste canister configured to store nuclear waste and positioned in the hazardous waste repository

In another aspect combinable with any of the previous aspects, the casing includes carbon-steel.

In another aspect combinable with any of the previous aspects, the coating includes a corrosion-resistant and scratch-resistant coating.

In another aspect combinable with any of the previous aspects, the coating includes at least one of quartz, diamond-like carbon (DLC), hard chrome, high velocity oxygen fuel (HVOF), Hardide®, or other glasses.

Another aspect combinable with any of the previous aspects further includes another coating attached to an interior surface of the casing.

In another aspect combinable with any of the previous aspects, the another coating includes at least one of a corrosion resistant alloy (CRA) or stainless steel.

In another aspect combinable with any of the previous aspects, the another coating includes a corrosion-resistant and scratch-resistant coating.

In another aspect combinable with any of the previous aspects, the another coating includes at least one of quartz or DLC.

In another aspect combinable with any of the previous aspects, the nuclear waste canister is configured to be retrievable from the drillhole at any time for a period of time.

In another aspect combinable with any of the previous aspects, the period of time is set as an industry requirement in order to use the drillhole as an interim storage facility.

In another aspect combinable with any of the previous aspects, the period of time ranges from a few years to up to 50 years.

Another aspect combinable with any of the previous aspects further includes a plug positioned to seal the substantially vertical portion of the drillhole to transform the hazardous waste repository into a permanent hazardous waste repository.

Implementations according to the present disclosure may include one or more of the following features. For example, a hazardous material canister for a hazardous waste repository formed in a human-unoccupiable drillhole may be more easily and efficiently emplaced or retrieved. As another example, one or more casings for a hazardous waste repository formed in a human-unoccupiable drillhole may be coated and/or formed to prevent or help prevent crevice corrosion.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous material storage repository that includes one or more hazardous material canisters according to the present disclosure.

FIGS. 2A-2B schematically illustrate a chemical reaction of crevice corrosion that may occur in a hazardous material storage repository that includes one or more hazardous material canisters according to the present disclosure.

FIG. 2C illustrates an interface between a casing surface and a canister emplaced within a hazardous material storage repository that includes one or more hazardous material canisters according to the present disclosure.

FIG. 2D schematically illustrates a geometry between two rounded surfaces such as an interface between a casing surface and a canister emplaced within a hazardous material storage repository that includes one or more hazardous material canisters according to the present disclosure.

FIG. 2E illustrates an example implementation of an exterior surface of a canister emplaced within a hazardous material storage repository that includes one or more hazardous material canisters according to the present disclosure.

FIG. 2F schematically illustrates another example implementation of an exterior surface of a canister emplaced within a hazardous material storage repository that includes one or more hazardous material canisters according to the present disclosure.

FIGS. 3A-3C schematically illustrate example implementations of a canister positionable within a hazardous material storage repository that includes multiple retrieval mechanisms.

FIGS. 4A-4F schematically illustrate example implementations of a canister positionable within a hazardous material storage repository that includes, for example, an open-hole or damaged drillhole.

### DETAILED DESCRIPTION

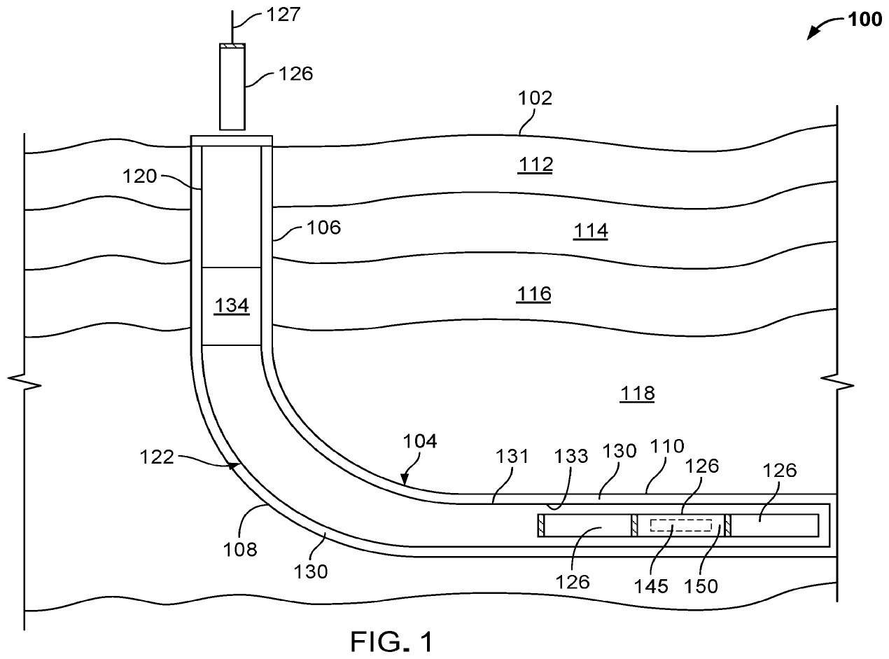

FIG. 1 is a schematic illustration of an example implementation of a hazardous material storage repository system 100, e.g., a subterranean location for the interim (e.g., days, months, years) or long-term (e.g., tens, hundreds, or thousands of years or more), but retrievable, safe and secure storage of hazardous material (e.g., radioactive material, such as nuclear waste which can be spent nuclear fuel (SNF), TRansUranic (TRU), or high level waste, as some examples). For example, this figure illustrates the example hazardous material storage repository system 100 once one or more canisters 126 of hazardous material have been deployed in a subterranean layer 118, as well as during a deployment of a particular canister 126 on a drillhole conveyance 127 (e.g., tubular conveyance, wirelines conveyance, or otherwise) into an entry of a drillhole 104. As illustrated, the hazardous material storage repository system 100 includes the drillhole 104 (or wellbore) formed (e.g., drilled or otherwise) from a terranean surface 102 and through multiple subterranean layers 112, 114, 116, and 118. Although the terranean surface 102 is illustrated as a land surface, terranean surface 102 may be a sub-sea or other underwater surface, such as a lake or an ocean floor or other surface under a body of water. Thus, the present disclosure contemplates that the drillhole 104 may be formed under a body of water from a drilling location on or proximate the body of water.

The illustrated drillhole 104 is a directional drillhole in this example of hazardous material storage repository system 100, but in other examples, may be generally vertical, slanted or tilted, or other configuration. For instance, the drillhole 104 includes a substantially vertical portion 106 coupled to a radiussed or curved portion 108, which in turn is coupled to a substantially horizontal portion 110. As used in the present disclosure, “substantially” in the context of a drillhole orientation, refers to drillholes that may not be exactly vertical (e.g., exactly perpendicular to the terranean surface 102) or exactly horizontal (e.g., exactly parallel to the terranean surface 102), or exactly inclined at a particular incline angle relative to the terranean surface 102. In other words, vertical drillholes often undulate offset from a true vertical direction, that they might be drilled at an angle that deviates from true vertical, and inclined drillholes often undulate offset from a true incline angle. Further, in some aspects, an inclined drillhole may not have or exhibit an exactly uniform incline (e.g., in degrees) over a length of the drillhole. Instead, the incline of the drillhole may vary over its length (e.g., by 1-5 degrees). As illustrated in this example, the three portions of the drillhole 104—the vertical portion 106, the radiussed portion 108, and the horizontal portion 110—form a continuous drillhole 104 that extends into the Earth. As used in the present disclosure, the drillhole 104 (and drillhole portions described) may also be called wellbores. Thus, as used in the present disclosure, drillhole and wellbore are largely synonymous and refer to bores formed through one or more subterranean formations that are not suitable for human-occupancy (i.e., are too small in diameter for a human to fit there within).

The illustrated drillhole 104, in this example, has a surface casing 120 positioned and set around the drillhole 104 from the terranean surface 102 into a particular depth in the Earth. For example, the surface casing 120 may be a relatively large-diameter tubular member (or string of members) set (e.g., cemented) around the drillhole 104 in a shallow formation. As used herein, “tubular” may refer to a member that has a circular cross-section, elliptical cross-section, or other shaped cross-section. For example, in this implementation of the hazardous material storage repository system 100, the surface casing 120 extends from the terranean surface through a surface layer 112. The surface layer 112, in this example, is a geologic layer comprised of one or more layered rock formations. In some aspects, the surface layer 112 in this example may or may not include freshwater aquifers, salt water or brine sources, or other sources of mobile water (e.g., water that moves through a geologic formation). In some aspects, the surface casing 120 may isolate the drillhole 104 from such mobile water, and may also provide a hanging location for other casing strings to be installed in the drillhole 104. Further, although not shown, a conductor casing may be set above the surface casing 120 (e.g., between the surface casing 120 and the surface 102 and within the surface layer 112) to prevent drilling fluids from escaping into the surface layer 112.

As illustrated, a production casing 122 is positioned and set within the drillhole 104 downhole of the surface casing 120. Although termed a “production” casing, in this example, the casing 122 may or may not have been subject to hydrocarbon production operations. Thus, the casing 122 refers to and includes any form of tubular member that is set (e.g., cemented) in the drillhole 104 downhole of the surface casing 120. In some examples of the hazardous material storage repository system 100, the production casing 122 may begin at an end of the radiussed portion 108 and extend throughout the horizontal portion 110. The casing 122 could also extend into the radiussed portion 108 and into the vertical portion 106.

As shown, cement 130 is positioned (e.g., pumped) around the casings 120 and 122 in an annulus between the casings 120 and 122 and the drillhole 104. The cement 130, for example, may secure the casings 120 and 122 (and any other casings or liners of the drillhole 104) through the subterranean layers under the terranean surface 102. In some aspects, the cement 130 may be installed along the entire length of the casings (e.g., casings 120 and 122 and any other casings), or the cement 130 could be used along certain portions of the casings if adequate for a particular drillhole 104. The cement 130 can also provide an additional layer of confinement for the hazardous material in canisters 126.

The drillhole 104 and associated casings 120 and 122 may be formed with various example dimensions and at various example depths (e.g., true vertical depth, or TVD). For instance, a conductor casing (not shown) may extend down to about 120 feet TVD, with a diameter of between about 28 in. and 60 in. The surface casing 120 may extend down to about 2500 feet TVD, with a diameter of between about 22 in. and 48 in. An intermediate casing (not shown) between the surface casing 120 and production casing 122 may extend down to about 8000 feet TVD, with a diameter of between about 16 in. and 36 in. The production casing 122 may extend inclinedly (e.g., to case the horizontal portion 110) with a diameter of between about 11 in. and 22 in. The foregoing dimensions are merely provided as examples and other dimensions (e.g., diameters, TVDs, lengths) are contemplated by the present disclosure. For example, diameters and TVDs may depend on the particular geological composition of one or more of the multiple subterranean layers (112, 114, 116, and 118), particular drilling techniques, as well as a size, shape, or design of a hazardous material canister 126 that contains hazardous material to be deposited in the hazardous material storage repository system 100. In some alternative examples, the production casing 122 (or other casing in the drillhole 104) could be circular in cross-section, elliptical in cross-section, or some other shape.

As illustrated, the vertical portion 106 of the drillhole 104 extends through subterranean layers 112, 114, and 116, and, in this example, lands in a subterranean layer 118. As discussed above, the surface layer 112 may or may not include mobile water. In this example, a mobile water layer 114 is below the surface layer 112 (although surface layer 112 may also include one or more sources of mobile water or liquid). For instance, mobile water layer 114 may include one or more sources of mobile water, such as freshwater aquifers, salt water or brine, or other source of mobile water. In this example of hazardous material storage repository system 100, mobile water may be water that moves through a subterranean layer based on a pressure differential across all or a part of the subterranean layer. For example, the mobile water layer 114 may be a permeable geologic formation in which water freely moves (e.g., due to pressure differences or otherwise) within the layer 114. In some aspects, the mobile water layer 114 may be a primary source of human-consumable water in a particular geographic area. Examples of rock formations of which the mobile water layer 114 may be composed include porous sandstones and limestones, among other formations.

Other illustrated layers, such as the layer 116 and the storage layer 118, may include immobile water. Immobile water, in some aspects, is water (e.g., fresh, salt, brine), that is not fit for human or animal consumption, or both. Immobile water, in some aspects, may be water that, by its motion through the layers 116 or 118 (or both), cannot reach the mobile water layer 114, terranean surface 102, or both, within 10,000 years or more (such as to 1,000,000 years).

One or both of subterranean layers 116 or 118 may be an impermeable layer. An impermeable layer, in this example, may not allow mobile water to pass through. Thus, relative to the mobile water layer 114, an impermeable layer may have low permeability, e.g., on the order of nanodarcy permeability. Additionally, in this example, an impermeable layer may be a relatively non-ductile (i.e., brittle) geologic formation. One measure of non-ductility is brittleness, which is the ratio of compressive stress to tensile strength. In some examples, the brittleness of the impermeable layer 116 may be between about 20 MPa and 40 MPa. In this example, rock formations of which an impermeable layer may be composed include, for example, certain kinds of sandstone, mudstone, clay, and slate that exhibit permeability and brittleness properties as described above. In alternative examples, an impermeable layer may be composed of an igneous rock, such as granite.

Below the layer 116 is the storage layer 118. The storage layer 118, in this example, may be chosen as the landing for the horizontal portion 110, which stores the hazardous material, for several reasons. Relative to the subterranean layer 116 or other layers, the storage layer 118 may be thick, e.g., between about 100 and 200 feet of total vertical thickness. Thickness of the storage layer 118 may allow for easier landing and directional drilling, thereby allowing the horizontal portion 110 to be readily emplaced within the storage layer 118 during constructions (e.g., drilling). If formed through an approximate horizontal center of the storage layer 118, the horizontal portion 110 may be surrounded by about 50 to 100 feet of the geologic formation that comprises the storage layer 118. Further, the storage layer 118 may also have only immobile water, e.g., due to a very low permeability of the layer 118 (e.g., on the order of milli- or nanodarcys). In addition, the storage layer 118 may have sufficient ductility, such that a brittleness of the rock formation that comprises the layer 118 is between about 3 MPa and 10 MPa. Examples of rock formations of which the storage layer 118 may be composed include: shale and anhydrite. Further, in some aspects, hazardous material may be stored below the storage layer, even in a permeable formation such as sandstone or limestone, if the storage layer is of sufficient geologic properties to isolate the permeable layer from the mobile water layer 114.

In some aspects, the formation of the storage layer 118 and/or an impermeable layer may form a leakage barrier, or barrier layer to fluid leakage that may be determined, at least in part, by the evidence of the storage capacity of the layer for hydrocarbons or other fluids (e.g., carbon dioxide) for hundreds of years, thousands of years, tens of thousands of years, hundreds of thousands of years, or even millions of years. For example, the barrier layer of the storage layer 118 and/or an impermeable layer may be defined by a time constant for leakage of the hazardous material more than 10,000 years (such as between about 10,000 years and 1,000,000 years) based on such evidence of hydrocarbon or other fluid storage.

The present disclosure contemplates that there may be many other layers between or among the illustrated subterranean layers 112, 114, 116, and 118. For example, there may be repeating patterns (e.g., vertically), of one or more of the mobile water layer 114, subterranean layer 116, and storage layer 118. Further, in some instances, the storage layer 118 may be directly adjacent (e.g., vertically) the mobile water layer 114, i.e., without an intervening impermeable layer 116. In some examples, all or portions of the radiussed drillhole portion 108 and the horizontal drillhole portion 110 may be formed below the storage layer 118, such that the storage layer 118 (e.g., shale or other geologic formation with characteristics as described herein) is vertically positioned between the horizontal drillhole 110 and the mobile water layer 114.

In this example, the horizontal portion 110 of the drillhole 104 includes a storage area in a distal part of the portion 110 into which hazardous material may be retrievably placed for long-term storage. For example, the conveyance 127 such as a work string (e.g., tubing, coiled tubing, wireline, or otherwise) or other downhole conveyance (e.g., tractor) may be moved into the cased drillhole 104 to place one or more (three shown but there may be more or less) hazardous material canisters 126 into long term, but in some aspects, retrievable, storage in the portion 110.

Each canister 126 may enclose hazardous material (shown as material 145). Such hazardous material, in some examples, may be biological or chemical waste or other biological or chemical hazardous material. In some examples, the hazardous material may include nuclear material, such as SNF recovered from a nuclear reactor (e.g., commercial power or test reactor) or military nuclear material (such as TRU waste). Spent nuclear fuel, in the form of nuclear fuel pellets, may be taken from the reactor and not modified. Nuclear fuel pellet are solid, although they can contain and emit a variety of radioactive gases including tritium (13 year half-life), krypton-85 (10.8 year half-life), and carbon dioxide containing C-14 (5730 year half-life). Other hazardous material 145 may include, for example, radioactive liquid, such as radioactive water from a commercial power (or other) reactor.

In some aspects, the storage layer 118 can contain any radioactive output (e.g., gases) within the layer 118, even if such output escapes the canisters 126. For example, the storage layer 118 can be selected based on diffusion times of radioactive output through the layer 118. For example, a minimum diffusion time of radioactive output escaping the storage layer 118 can be set at, for example, fifty times a half-life for any particular component of the nuclear fuel pellets. Fifty half-lives as a minimum diffusion time would reduce an amount of radioactive output by a factor of 1×10⁻¹⁵. As another example, setting a minimum diffusion time to thirty half-lives would reduce an amount of radioactive output by a factor of one billion.

For example, plutonium-239 is often considered a dangerous waste product in SNF because of its long half-life of 24,100 years. For this isotope, 50 half-lives would be 1.2 million years. Plutonium-239 has low solubility in water, is not volatile, and as a solid, its diffusion time is exceedingly small (e.g., many millions of years) through a matrix of the rock formation that comprises the illustrated storage layer 118 (e.g., shale or other formation). The storage layer 118, for example comprised of shale, may offer the capability to have such isolation times (e.g., millions of years) as shown by the geological history of containing gaseous hydrocarbons (e.g., methane and otherwise) for several million years. In contrast, in conventional nuclear material storage methods, there was a danger that some plutonium might dissolve in a layer that comprised mobile ground water upon confinement escape.

In some aspects, the drillhole 104 can be formed for the primary purpose of long-term storage of hazardous materials. In alternative aspects, the drillhole 104 may have been previously formed for the primary purpose of hydrocarbon production (e.g., oil, gas). For example, storage layer 118 can be a hydrocarbon bearing formation from which hydrocarbons were produced into the drillhole 104 and to the terranean surface 102. In some aspects, the storage layer 118 may have been hydraulically fractured prior to hydrocarbon production. Further, in some aspects, the production casing 122 may have been perforated prior to hydraulic fracturing. In such aspects, the production casing 122 can be patched (e.g., cemented) to repair any holes made from the perforating process prior to a deposit operation of hazardous material. In addition, any cracks or openings in the cement between the casing and the drillhole can also be filled at that time.

Although not shown, a backfill material can be positioned or circulated into the drillhole 104. In such an example, the backfill material surrounds the canisters 126 and may have a level that extends uphole to at or near a drillhole seal 134 (e.g., permanent packer, plug, or other seal). In some aspects, a backfill material can absorb radioactive energy (e.g., gamma rays or other energy). In some aspects, a backfill material can have a relatively low thermal conductivity, thereby acting as an insulator between the canisters 126 and the casing 122.

As shown in FIG. 1, a backfill material 150 can be positioned or placed within one or more of the canisters 126 to surround the hazardous material 145. In some aspects, the backfill material 150 may absorb radioactive energy (e.g., gamma rays or other energy). In some aspects, the backfill material 150 may have a relatively low thermal conductivity, thereby acting as an insulator between the hazardous material 145 and the canister 126. In some aspects, the backfill material 150 may also provide a stiffening attribute to the canister 126, e.g., reducing crushability, deformation, or other damage to the canister 126.

In some aspects, one or more of the previously described components of the system 100 may combine to form an engineered barrier of the hazardous waste material repository 100. For example, in some aspects, the engineered barrier is comprised of one, some, or all of the following components: the storage layer 118, the cement 130, the casing 122, the canister 126, the backfill material 150 (and/or additional backfill material within the drillhole 104), the seal 134, and the hazardous material 145, itself. In some aspects, one or more of the engineered barrier components may act (or be engineered to act) to: prevent or reduce corrosion in the drillhole 104, prevent or reduce escape of the hazardous material 145; reduce or prevent thermal degradation of one or more of the other components; and other safety measures to ensure that the hazardous material 145 does not reach the mobile water layer 114 (or surface layer 112, including the terranean surface 102).

As noted, the system 100 may be constructed and operated for the long-term (e.g., permanent) storage of hazardous material as well as the interim storage of hazardous material, such as nuclear waste. In some aspects, interim storage is temporary storage (e.g., storage for a particular amount of time less than what could be considered permanent) done when permanent (e.g., tens to hundreds of years or more) disposal options may not be available. Conventional interim storage for nuclear waste, such as spent nuclear fuel or high level waste, is typically done at the same site as that of the nuclear reactor that produced such waste. For the first 3 to 5 years (e.g., after removal from a reactor), the interim storage is typically done in a pool of water since the water provides good cooling for the nuclear waste while the short-lived radioisotopes decay and produce heat. If no other facilities are available, the nuclear waste can be kept in the pool for several decades. Any time after the initial cooling period of 3 to 5 years, the waste can be transferred to dry interim storage. Currently about ⅓ of the spent nuclear fuel in the United States has been transferred to such storage, commonly called “dry cask” storage. The dry casks can be licensed for two or more decades, but they are not designed to be used for permanent disposal. When transporting the spent nuclear fuel to a permanent storage facility, the current method consists of opening the dry casks, repackaging the spent fuel into suitable disposal canisters, transporting the canisters to a disposal site, inserting them into a repository, and then sealing the repository.

In some aspects, to be used as an interim storage facility, hazardous waste material repository 100 can allow for the emplaced hazardous waste (e.g., spent nuclear fuel) to be retrieved at any time. Even in a disposal facility, such retrievability can be required for a period ranging from a few years to up to fifty years. This can be required because, until a license for disposal is issued, the final residing place of the spent nuclear fuel is not assured. It might happen, for example, that a better method for disposal is found, possibly involving reprocessing of the fuel. Or it might be determined that the fuel has useful applications, and disposal is not the preferred option. Therefore, using the hazardous waste material repository 100 for interim storage may assure the retrievability of the hazardous waste material 145. The present disclosure provides an enhanced security for the retrievability of waste from a human-unoccupiable directional drillhole, and therefore provides additional assurance that can help obtain a license for interim storage in such a directional drillhole.

As shown, the hazardous waste material repository 100 includes a lining of the drillhole 104 with, typically, a carbon-steel pipe, i.e., casing 122. In some aspects, use of the casing 122 may not provide an environment from which the stored hazardous waste material can be retrieved for more than a decade or two, falling short of a potentially required time period of retrievability of an interim storage facility of, e.g., nuclear waste. The primary reason that casings fail in periods of a decade or more is from corrosion. This typically occurs because of the presence of oxygen and water (triggering the oxidation process commonly called “rust”) and because of other elements in the deep brines that are known to cause corrosion (particularly acids, salt, chlorine, bromine). In principle, the casings could be made of corrosion-resistant alloys (CRAs), including nickel-chromium-molybdenum alloys 22 and 625, but the cost of such alloys is prohibitive. Coating carbon-steel casings with CRAs reduces the cost, but the placement of casings in deep drillholes typically involves pushing the casing past hard rock, and scratches on the surface can penetrate the thin protective layers of CRAs and cause corrosion and inability to retrieve the spent fuel.

In some aspects, the casing 122 is treated to ensure or help ensure corrosion resistance and long life within the directional drillhole 104 to overcome the physical and economic challenges inherent in using directional drillholes for the interim storage of hazardous waste material. When an exterior corrosion-resistant layer of the casing 122 is scratched by the rock wall of the drillhole, the thin passivation film that corrosion resistant coatings rely on to prevent corrosion is disturbed. Because this film generally requires oxygen to form, and because oxygen is not easily available in the drillhole 104, the layer of the casing 122 will fail over time if scratched. Therefore, one way to ensure the corrosion resistance of the casing 122 is to also ensure its scratch resistance. In some aspects, this is accomplished by coating the outside surface of the casing 122 (the exterior surface directly adjacent and in contact with rock when the casing is deployed in the drillhole) with scratch-resistant coatings that also offer corrosion resistance against the conditions commonly found in the drillhole 104. In an example implementation, all or a portion of the casing 122 (as well as other casings) in the drillhole 104 includes an external coating 131 attached to an exterior surface of the casing 122 (the surface in contact with the cement 130 and/or the rock of storage layer 118). In some aspects, all or a portion of the casing 122 (as well as other casings) in the drillhole 104 includes an internal coating 133 attached to an interior surface of the casing 122 (the surface adjacent the storage area in which the canisters 126 are emplaced). Such coated casings will enable the canisters that store the canisters 126 in the drillhole 104 to be retrieved at any time from the drillhole 104 for the period of time required to serve as an interim storage facility before the casing 122 corrode away into an unworkable system.

In some aspects, coating materials for one or both of the external coating 131 or the internal coating 133 of the casing 122 (or other casings) may include quartz, other glasses, or DLC (diamond-like carbon), or a combination thereof Although DLC may be generally considered too expensive to use for coating casings of production wells, it can be practical when the wellbores are being used for the interim storage of hazardous waste material. The saved cost in using directional drillholes over current methods justifies the cost of coating the casings in DLC. This is also cheaper than constructing the entire casing out of CRA. In other aspects, other materials can be used in place of quartz or DLC, such as hard chrome, HVOF, and Hardide.® These materials also offer scratch resistance and corrosion resistance, similar to that of quartz or DLC.

As described, in some aspects, the inner surface of the casing 122 may also be coated with internal coating 133. In some aspects, the inner surface of the casing 122 can be filled with brine and mud, and must also be protected from corrosion in order to maintain the retrievability of the hazardous waste material. In some aspects, this internal coating 133 may consist of quartz and DLC, similar to the external coating 131. In another implementation, the internal coating 133 can instead be comprised of CRAs and stainless steel. These materials, while less scratch-resistant than DLC or quartz, are still viable because the scratching to the interior of the casing 122 comes primarily from the insertion of canisters 126, which can have a surface that is smoother and less conducive to causing scratches than is the bare rock that contacts the exterior surface of the casing 122.

In an example implementation, the drillhole 104 can be transformed from an interim storage facility into a permanent disposal repository by sealing the vertical access hole of the drillhole 104, such as with the wellbore seal 134 (or additional seals within the drillhole 104). In example implementations, by transforming the interim storage facility into a permanent storage facility through by sealing the vertical access hole, the entire process of storing hazardous waste material is drastically simplified and improved. Rather than having three storage facilities (e.g., the water, the dry cask, and the repository) with the transfer to each facility requiring significant tools and resources, the disclosed implementations utilize two storage facilities (e.g., the water and the directional drillhole 104). No transfer of spent fuel is required from interim storage to permanent disposal, and because the act of sealing the drillhole 104 is efficient, this process can be done at a much lower cost than the prior methods known in the industry.

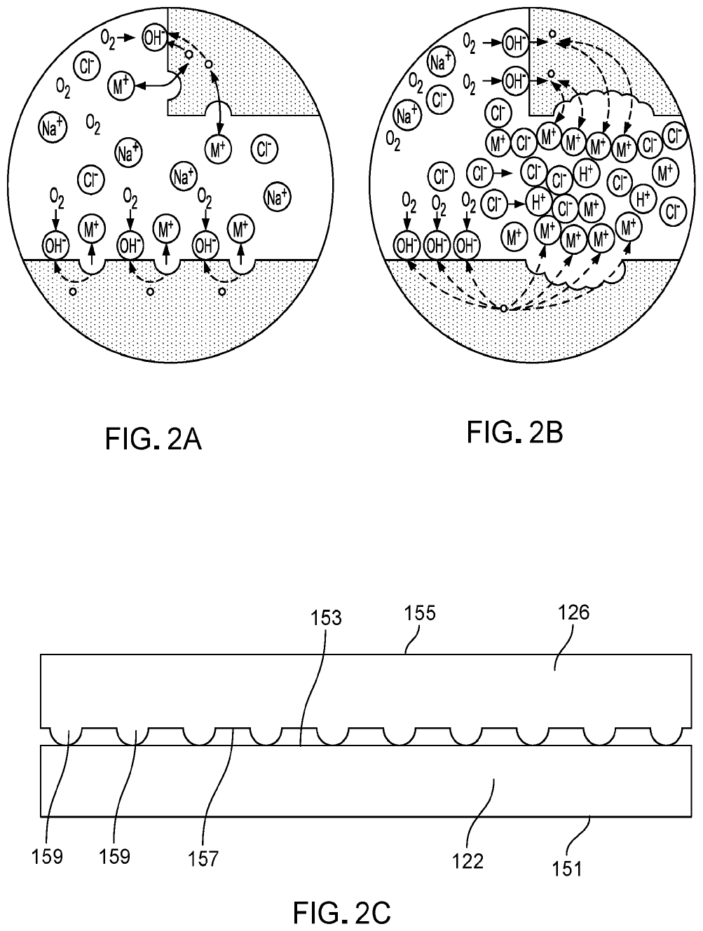

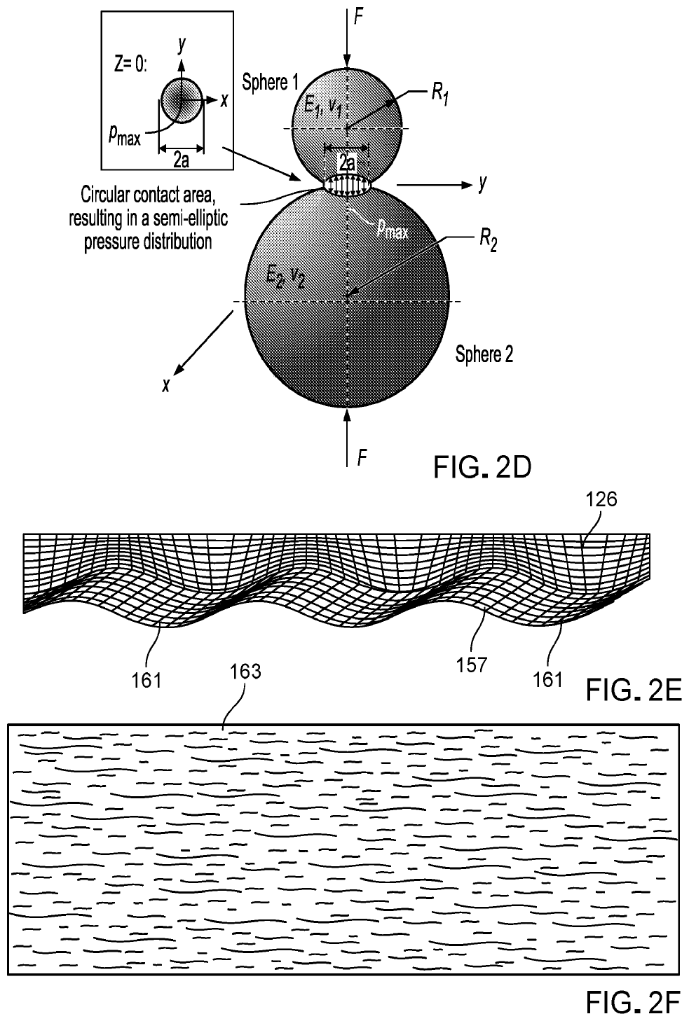

As noted, corrosion may occur on or with one or more components of the hazardous waste material repository 100. Crevice corrosion is a special case of concentration-cell corrosion that may occur in the hazardous waste material repository 100. In such corrosion, a narrow region with highly restricted access to a larger body of fluid concentrates metal ions that dissolve from the surface of the metal. Even if the metal is a corrosion-resistant-alloy (CRA), this concentration can cause a breakdown of the thin passive film layer that retards corrosion of the CRA. This type of corrosion is shown in FIGS. 2A and 2B (copyright M. G. Fontana, Corrosion Engineering, 3rd ed., McGraw-Hill, New York, 1986), which illustrate the chemical reaction and ion exchange that take place during crevice corrosion.

Crevice corrosion may take place because the pathway to mixing with the larger corrosive fluid is restricted, and so ions released from the metal (e.g., CRA) cannot be diluted by mixing with the corrosive fluid (which might be, in one implementation, brine). A type of crevice corrosion that may not be eliminated by welding is corrosion on the bottom of one or more of the canisters 126, where the canisters 126 make contact with the interior surface of the casing 122 (which may be made of an alloy of steel, a CRA, a coated material (e.g. fused quartz or diamond coated metal), a ceramic, or another material). Because the radius of the canister 126 is relatively large, the space between the canister 126 and the interior surface of the casing 122 can be narrow and behave as a crevice for corrosion development.

In some aspects, crevice corrosion can be prevented or reduced between the canister 126 and the casing 122. To support crevice corrosion, the crevice width has to be wide enough to allow the corroding fluid (e.g., brine) in, but sufficiently narrow to keep the fluid stagnant such that it does not mix with the ions released from a housing of the canister 126 (e.g., made of CRA). Thus, in some aspects, crevice corrosion can be avoided by keeping the depth of the crevice sufficiently small. Here, “depth” refers to the distance to a region that is not stagnant, not the distance between the surfaces of the crevice.

For two surfaces in contact, the depth of the crevice, for example the distance in which the separation between the two surfaces is small (e.g., less than a few microns) can be kept below the critical depth by shaping one or more of the surfaces (e.g., one or more of an external surface of the canister 126 or the interior surface of the casing 122). An example implementation is shown in FIG. 2C. In this implementation, at least a portion of an exterior surface 157 of the canister 126 can be curved (e.g., with half-spheres 159 as shown) so that contact between an interior surface 153 of the casing 122 and the nuclear waste canister 126 occurs on the surfaces of multiple half-spheres 159. In this example, the canister 126 also includes an interior surface 155 (e.g., of the housing) and the casing 122 includes an exterior surface 151 that is adjacent, e.g., the cement 130 or a rock formation.

In some aspects, the material of the canister 126 and the casing 122 may both be compressed by the weight of the canister 126, which may cause the area of contact (e.g., between the half-spheres 159 and the interior surface 153) to be larger than a point. The amount of compression can be calculated by using one or more equations. For two spheres in contact, the equation is:

$$a = \sqrt[3]{\frac{3 F [ \frac{1 - {v}_{1}^{2} + 1 - {v}_{2}^{2}}{{E}_{1} {E}_{2}} ]}{4 ( \frac{1}{{R}_{1}} + \frac{1}{{R}_{2}} )}} ,$$

where a is the radius of the circle of contact, F is the force pushing the two surfaces together, E is the modulus of elasticity for each of the surfaces, v is the Poisson ratio for the two materials, and R is the radius of curvature of the two surfaces. These parameters are illustrated geometrically in FIG. 2D (e.g., with Sphere 1 being a half-sphere 159 and Sphere 2 being the interior surface 153 of the casing 122 that has a circular cross-section).

In some aspects, crevice corrosion may not take place if a, the radius of the circle, is less than a few millimeters, e.g., a critical depth for crevice corrosion. In an example implementation with a 1 metric ton canister 126, this can be accomplished by having the force distributed over a sufficient number of half-spheres 159 (e.g., formed on the exterior surface 157of the canister 126, or alternatively, the interior surface 153 of the casing 122). In an example implementation with 1000 half-spheres 159, the force on each half-sphere is 1 kg weight, or 9.8 Newtons. Using typical values of the material parameters for steel, with modulus of elasticity, E, approximately 1011 Pa, and Poisson's ratio, v, approximately 0.2, taking R₁=0.01 m and assuming R₂ is much larger (i.e., representing a flat surface), the radius of contact, a, for this example is about 10×10⁻⁶ meters, or 1 μm. Because this is much less than the critical depth for crevice corrosion, crevice corrosion would not occur in this example.

Past the point of contact, the surface of the half-sphere 159 rises above the flat geometry of the interior surface 153 of the casing 122. This rise, h, can be determined at a distance, d, away from the contact point. If h is small, then h=d2/(2R), where R can be the radius of the half-sphere 159. In an example implementation with a critical crevice depth of 1 mm and a half-sphere of radius R=1 cm, this gap is 50 μm; at 2 mm it is 200 μm. In either example, the gap is sufficiently wide enough to inhibit crevice corrosion. In some aspects, the gap could be increased further by using a smaller value of R, that is, a smaller half-sphere 159, or another surface with a greater curvature. The rapid increase of gap size with distance from the contact region can assure that fluid flow will prevent the concentration of corroding ions in the region.

Other dimensions and geometries are possible. In another implementation, the radius, R, could be larger or smaller, and other materials could be used. In another implementation, the region of contact could be cylindrical, that is, long half-cylinders on the exterior surface 157 of the canister 126, instead of half-spheres. Each of these example implementations keep the contact distance sufficiently small to eliminate crevice corrosion.

FIG. 2E shows another implementation of a surface that can inhibit crevice corrosion. In this example, rather than having a circular profile (as in a sphere or a cylinder) of the half-spheres 159, the exterior surface 157 of the nuclear waste canister 126 can be undulating wave form 161 (e.g., with waves of a height, z, as a function of distance x represented by a sinusoidal surface: z=R sin(x/D)). In this example, the depth of the contact region can be below the critical depth for crevice corrosion. Of course, such an undulating surface 161 can be formed on the interior surface 153 of the casing 122 rather than the exterior surface 157 of the canister 126.

FIG. 2F shows another implementation of a surface that can inhibit crevice corrosion. In this implementation, a surface 163 is undulating, but not in a completely regular manner (e.g., a “rough surface”). In some aspects, an analysis of the rough surface's shape may show that it is very unlikely that any point of contact will have a contact depth greater than the critical contact depth for crevice corrosion. Surface 163 can be applied to the exterior surface 157 of the canister 126 or the interior surface 153 of the casing 122.

In alternative implementations, an object or number of objects (i.e., not integrally formed to either of the casing 122 or canister 126) can be placed in between the adjacent surfaces of the canister 126 and the casing 122. These example implementations may achieve the same effect (e.g., as the implementations in FIGS. 2C, 2E, and 2F) without altering the design of a canister 126 or casing 122, e.g., leaving them both smooth. In some aspects, these objects can be a set of spheres or rods or a layer of undulating shape in between the canister 126 and the casing 122. In some aspects, these objects could be made of any material, but in a preferred implementation the material would have a slow corrosion rate. In that configuration, the material could be a corrosion-resistant alloy (CRA), or it could be a material that does not corrode, such as fused quartz.

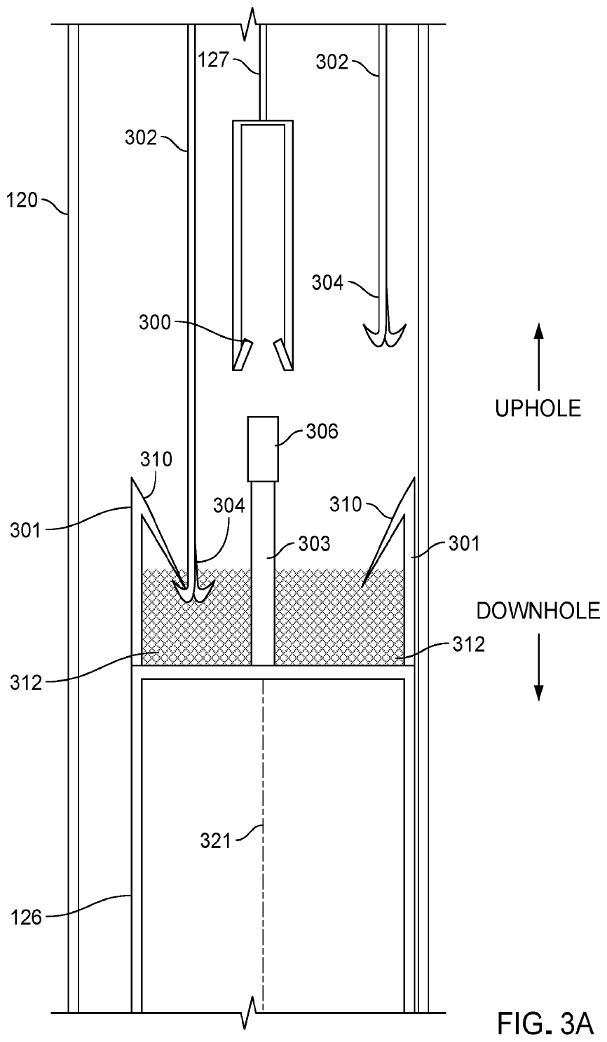

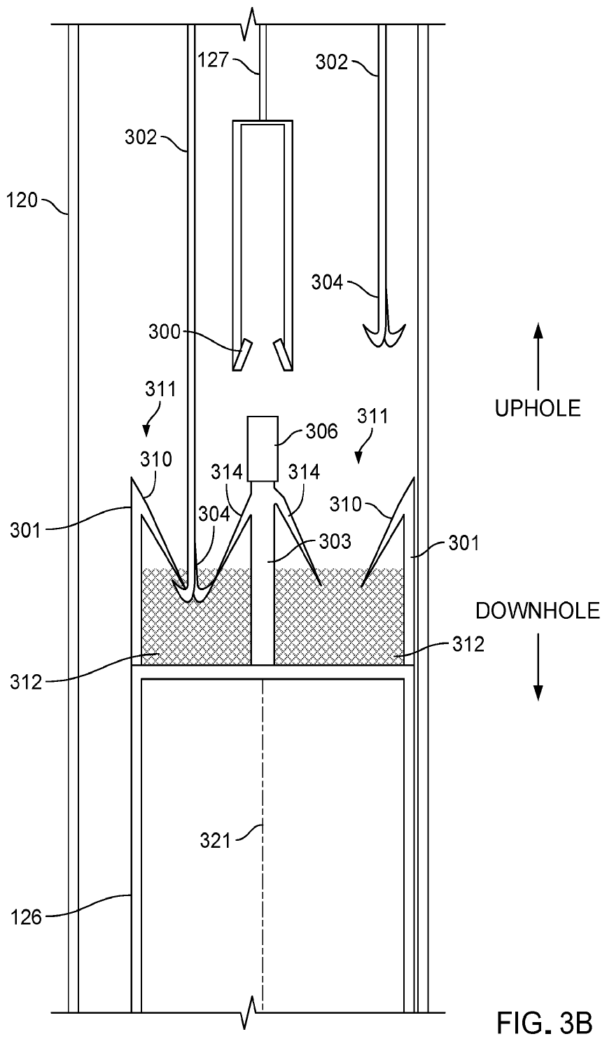

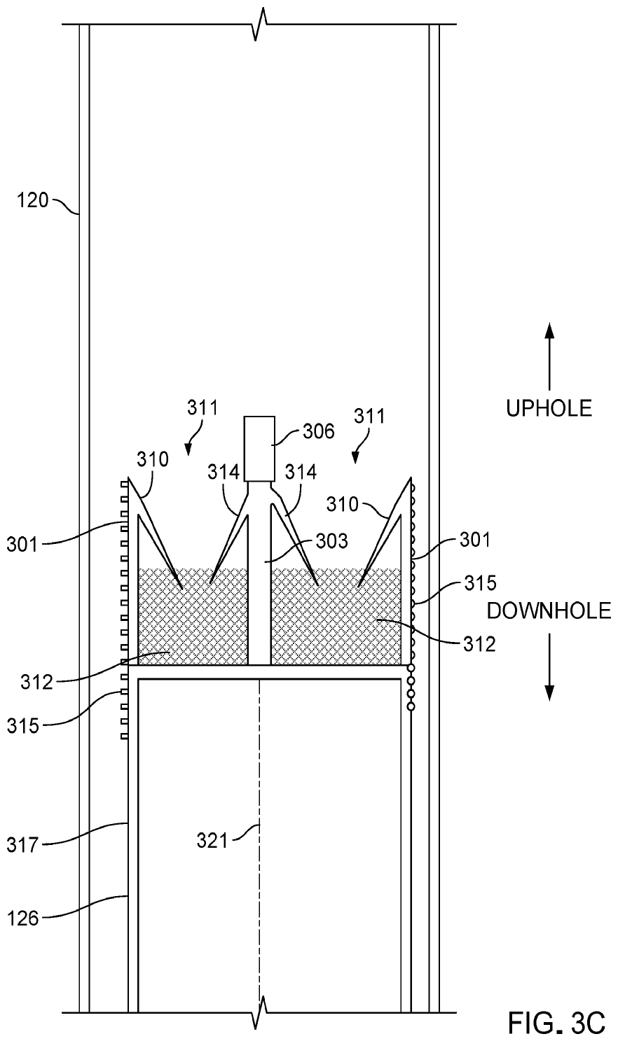

FIGS. 3A-3C schematically illustrate example implementations of a canister positionable within a hazardous material storage repository that includes multiple retrieval mechanisms. For example, as described, in some instances, hazardous waste material, including nuclear waste, can be disposed of in deep, human-unoccupiable directional drillholes in stable geologic formations (e.g., in or under subterranean formations). But to obtain a license to dispose of waste in this manner, it is typically required that the waste package (e.g., a nuclear waste canister 126) be retrievable for periods of several years to several decades.

During the emplacement process, the hazardous waste canister 126 shown in FIG. 1 can be put in place with the downhole conveyance 127, which can be, for example wireline, coiled tubing, or drill pipe. As shown in FIGS. 3A-3C, the downhole conveyance 127 can include a latching mechanism 300 at a downhole end of the conveyance 127 (collectively referred to as a “cable”) that connects to the canister 126. The latching mechanism 300 can connect to a receiving mechanism 306 on the canister 126 (referred to as a “knob,” although the receiving mechanism 306 may not be shaped like a knob). In particular configurations, the latching mechanism 300 on the cable can be actively controlled to open or close, and can be used to place the hazardous waste canister 126 into the drillhole 104 (as shown in FIGS. 3A-3C, through casing 120). The hazardous waste canister 126 can be lowered into the drillhole 124, emplaced, released, and the cable withdrawn; then at a later time, the cable can be lowered again into the drillhole 104 and the latching mechanism 300 reattached to the canister 126. The canister 126 can then be lifted to the surface 102 by the cable.

In a typical example of a latching mechanism 300, the cable has a tube at the end that fits inside a tube attached to the canister 126. The cable tube has spring-loaded sides, and with sufficient force can be pushed inside the knob. Alternatively, the knob 306 can fit inside the cable tube. Once inside, a ring is moved down the latching mechanism 300, locking it in place. The ring is typically moved by remote control, utilizing an electric signal from the surface 102.

If, however, the latching mechanism 300 fails to attach to the knob 306, then the canister 126 must be retrieved by other means in order to meet the retrievability requirement of the hazardous waste canister 126. Such recovery is often referred to as an “uncooperative” recovery, since the canister 126 no longer has a functioning connector 306 (or the latching mechanism 300 is not functioning). The loss of function could come from damage or from jamming, for example, if the shape of the cable tube is change by impact, or if rock or debris prevents the knob 306/latch 300 from operating as planned. Uncooperative recovery can be done using means that are referred to as “fishing.” Typically, a clamp is lowered into the hole and maneuvered around the canister. This then is tightened to make a connection to the canister, which then is lifted to the surface. In these conventional fishing methods, the first concern is often to clear the hole. Avoiding damage to the retrieved object is usually of secondary concern, since a drillhole with an object in it can delay operations, and delays are expensive. But for the storage of hazardous waste, retrieving a canister 126 in an undamaged manner is important, since the canister 126 contains highly dangerous material.

FIGS. 3A-3C illustrate example implementations of the hazardous waste canister 126 that will not interfere with (and can include) the latching mechanism 300, but which can serve as an alternative technique of recovery if that mechanism fails, while still preserving the integrity of the canister 126. A first example implementation is shown in FIG. 3A. In this example, an extension 301 is placed on the canister wall, with a lip 310 (e.g., that circumscribes the extension 301) around the end of the extension 301. In this example implementation, the extension 301 has the same outer diameter as the canister 126, but it could also be smaller or larger in diameter. At the end of the extension 301, the lip 310 bends inward towards a radial centerline of the canister 126, making a funnel shape that can guide a grappling hook 304 or other retrieval device towards the lip 310. In FIG. 3A, an example implementation is shown where a first grappling hook 304 on a cable 302 has become engaged, and a second grappling hook 304 on another cable 302 has not moved far enough downhole to engage the lip 310.

In some aspects, the lip 310 can be made of a highly corrosion-resistant allow, such as the nickel/molybdenum/chromium alloys 22 or 625. The lip 310 can be circular in cross-section, but may also have an edge that bends in towards the canister 126. In some aspects, a bend can make it easier for the grappling hooks 304 or other retrieval device to engage the lip 310. The bend can be similar in shape to that of a fish-hook (often referred to as a “barb” that makes a secure latch when it enters the skin of a fish).

In the example implementation of FIG. 3A, the region around the lip 310 can be kept clean by filling it with a filler material 312. The filler material 312 can be a material that keeps liquid and mud from intruding near the lip 310, but which, itself, may easily be penetrated by the grappling hooks 304 or other retrieval device. In some aspects, the filler material 312 can be made of aerogel, a material that is lightweight, strong enough to keep fluids and mud out of the space within the extension 301, and yet fragile enough that it would offer minimal resistance to the grappling hooks 304 or other retrieval device. In the example implementation shown in FIG. 3A, the first grappling hook 304 has broken through the filler material 312 and when pulled uphole, engages the lip 310.

In some aspects, the extension 301 and lip 310 as described could be a primary mechanism for the retrieval of a canister 126 from depth, but in other aspects this mechanism can also be used as a secondary technique that would facilitate the retrieval of the canister 126 in the situation in which the primary method (e.g., engagement of the knob 306 with the latching mechanism 300) fails.

Another example implementation is shown in FIG. 3B. In this implementation, a similar design to FIG. 3A is shown with the addition of a secondary lip 314. This secondary lip 314 can be added and attached to the knob 306 (or a post 303 that connects the knob 306 to the canister 126) to facilitate the guidance of the grappling hooks 304 to engage the secondary lip 314 and the lip 310. In FIG. 3B, this secondary lip 314 is shown attached to the knob 306; if there is a canister 126 with no knob, then the secondary lip 314 can be attached, e.g., to the housing of the canister 126.

In the implementation shown in FIG. 3B, the space between the secondary lip 314 and the lip 310 can be referred to as a mouth 311. If the lips 310 and 314 have cylindrical symmetry, then the mouth 311 will be circular in shape. However, the mouth 311 and the lips 310 and 314 need not be continuous; they could be discrete, arranged around the axis of symmetry by (for example) at 0°, 45°, 90°, 135°, 180°, 225°, 270°, or 315°, or at some other spacing, which need not be uniform.

In another implementation shown in FIG. 3C, enhancing the retrievability of a canister 126 may further be accomplished by providing a “grippable” surface 315 on an exterior surface 317 of the canister 126. One method of “fishing” for objects in deep drillholes is to send down a device that can surround the object and then “grab” it, either by a spring-loaded device, or by mechanically tightening the surrounding device. To increase the probability of a successful attachment, the surface 315 can be roughened, or can have ridges, threads, or other undulations or surface enhancements that make attachment more robust.

In FIG. 3C, the surface 315 is shown with ridges that have a roughly square cross section. However, any shape of the cross section can enhance grabbing by a fishing tool. For example, as shown in FIG. 3C, part of the surface 315 is shown with a roughly square cross-section while another part of the surface 315 has a semi-circular shape to the individual ridges. In some aspects, these ridges could surround the exterior surface 317 of the canister 126. In other aspects, such ridges can be discrete, consisting of small bumps separated from each other, but still enhancing the ability of a fishing device to grab the surface 317. In other aspects, such ridges could also be circular but forming a spiral around the exterior surface 317 of the canister 126, allowing a similar spiral effectively to screw on to the surface by turning around the radial centerline axis 321 of the canister 126.

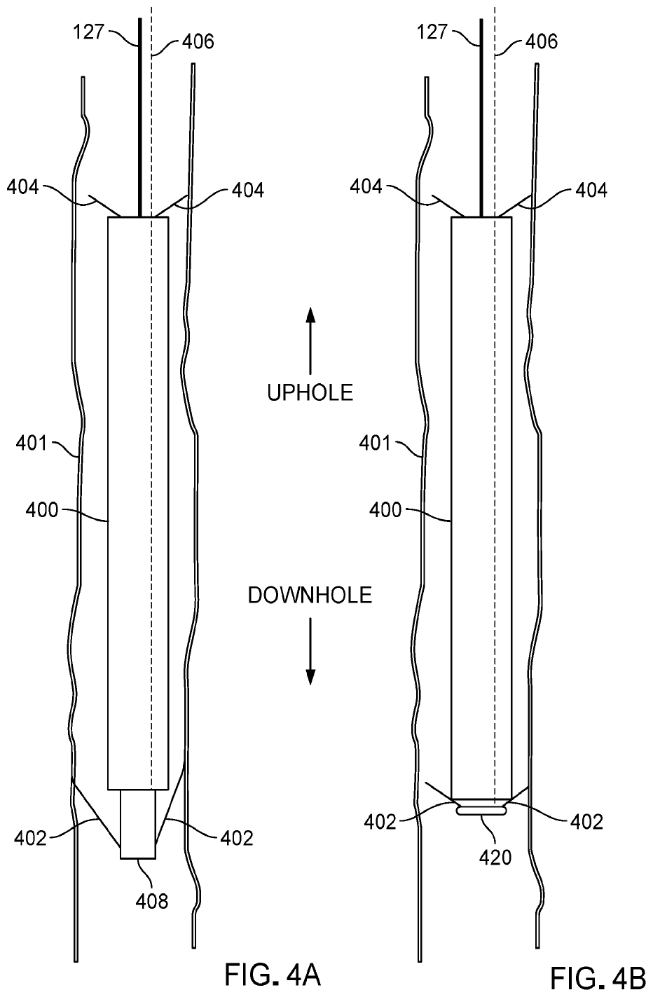

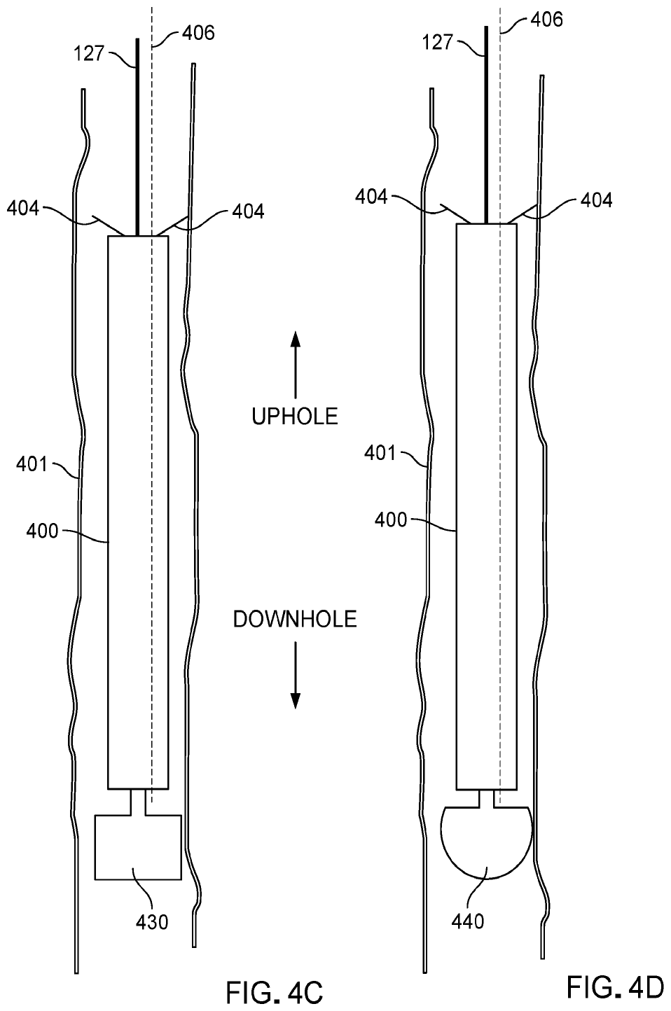

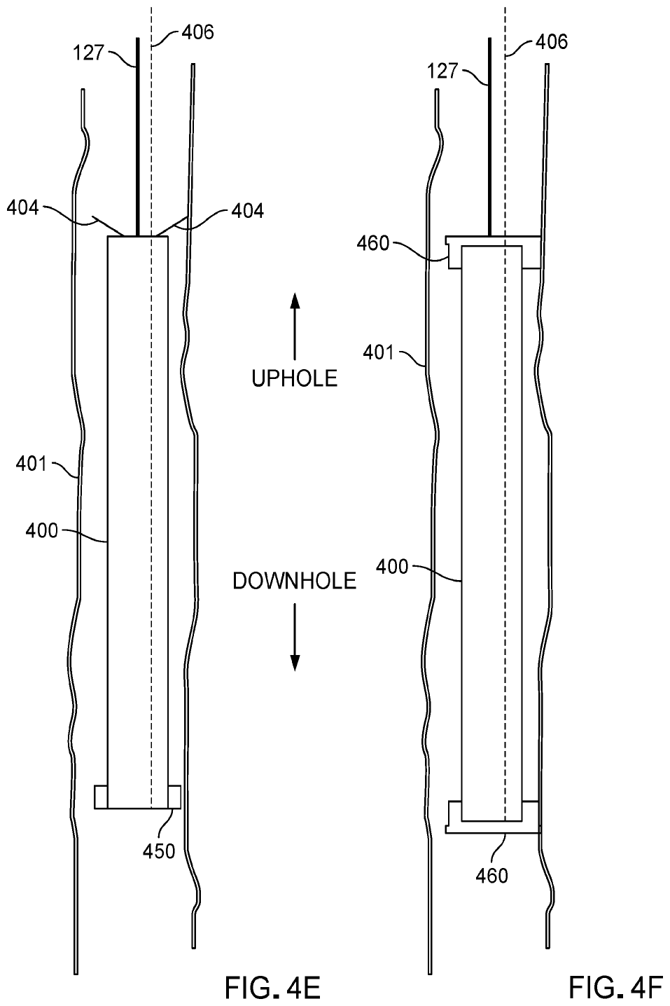

FIGS. 4A-4F schematically illustrate example implementations of a canister positionable within a hazardous material storage repository that includes, for example, an open-hole or damaged drillhole. For example, in some aspects, the drillhole 104 shown in FIG. 1, including one or more casings installed in the drillhole 104, may become damaged or blocked (e.g., partially) by rock pieces from the surrounding subterranean formation. In other aspects, one or more casings (such as casings 120 or 122) may be excluded from the hazardous waste repository 100 shown in FIG. 1 to achieve an “open hole” completion through all or part of the drillhole 104.

For example, when a canister 126 containing the hazardous waste 145 is moved (e.g., from the terranean surface 102) into the drillhole 104 for storage or disposal, there can be a possible danger that a shape or integrity of the drillhole 104 has changed since it was formed or last measured (e.g., measurement of a diameter of the drillhole 104). In some cases, the change of shape or integrity can be possible due to a subterranean formation that deforms with time, such as a salt layer or mudstone. In some cases, there can also be a partial collapse of one or more portions of the drillhole, thereby leading to debris filling part of the drillhole. If the drillhole has partially closed or otherwise changed shape, then there is a potential that the canister would become stuck in the drillhole. If that happens, “fishing” techniques can be used to retrieve a stuck canister 126, but if the canister 126 holds the hazardous material 145, then there is the additional danger that the fishing techniques can breach the canister 126 and release the hazardous material 145 into the drillhole 104 and possibly to the terranean surface 102 (or a source of mobile water at or near the surface 102).

In order to determine whether or not the drillhole 104 has collapsed or been compromised, measurements can be taken of one or more dimensions (e.g., diameter or otherwise) of the drillhole 104. In some aspects, the measurements are taken once per day or once per month. Such measurements are time consuming and may not detect drillhole shape changes that take place subsequent to a measurement. FIGS. 4A-4F show example implementations of a hazardous waste canister (such as canister 126) that can determine a drillhole condition during insertion of the hazardous waste canister into and through a drillhole with one or more measurement devices mounted on or to the hazardous waste canister. FIGS. 4A-4F also illustrate systems and method of preventing or reducing a possibility of a hazardous waste canister being stuck in a drillhole even without determining the drillhole condition through measurement of one or more dimensions of the drillhole.

In an example implementation shown in FIG. 4A, a hazardous waste canister 400 is shown within a drillhole 401. In this example, the drillhole 401 may be a vertical or directional drillhole that is an open-hole drillhole (e.g., excludes casings). In other aspects, however, the drillhole 401 may include one or more casings. As shown, the canister 400 includes a caliper jam preventer 408 that includes one or more single-use calipers 402 attached to or with the canister 400 at or near a downhole end of the canister 401. The canister 400 is moved or positioned into the drillhole 401 by the conveyance 127 (e.g., coiled tubing, wireline, wireline tractor, or otherwise). In some aspects, a detachable pusher may be connected between the canister 400 and the conveyance 127 (or as part of the conveyance 127). The canister 400 includes a single-use caliper 402 (or set of single use calipers 402) mounted on the downhole end of the canister 400 as shown. In some aspects, “single-use” refers to the possibility that such a caliper 402 would not be recoverable if detached from the caliper jam preventer 408, since the caliper 402, e.g., would be blocked from the drillhole entrance by the canister 400. Thus, the calipers or set of calipers 402 may be used only once.

In some aspects, the single-use caliper 402 may provide an ongoing measurement (e.g., during insertion of the canister 400) of one or more dimensions of the drillhole 401 (e.g., diameter or otherwise). These ongoing measurements (e.g., periodic measurements) may thus detect a presence of a distortion (e.g., a dimensional measurement less than expected or less than a threshold value) in the drillhole 401 that may impede the placement of the canister 400 within the drillhole 401. As shown, the single-use caliper 402 (or calipers 402) can be communicably coupled (e.g., through a wired or wireless connection 406) to an alert system on the terranean surface 102 (such as a processor-based alert system). Thus, measurements from the caliper 402 can be transmitted to the alert system through the alert signal 406. The transmitted data may include numerical measurements, an alert that indicates when a measurement is less than a threshold measurement that indicates a compromised drillhole, or both. Thus, the single-use caliper 402 may signal to the operator who is inserting the canister 400 that the drillhole 401 is not open, and the placement of the canister 400 should immediately be halted. At that time, the canister 400 can be pulled uphole to the surface 102 and the drillhole 401 reexamined by conventional techniques. In other example implementations, the caliper 402 can send a signal directly to the device (e.g., conveyance 127) that is moving the canister 400 through the hole to trigger an immediate halt.

In this example, the single-use caliper 402 can function as the hazardous waste canister 400 is bring inserted (e.g., from the terranean surface toward a hazardous waste repository formed in the drillhole 401). But the single-use caliper 402 can function as the canister 400 is being moved uphole as the canister is being retrieved (rather than downhole, if necessary). Also, as shown in the examiner of FIG. 4A, rear calipers 404 (or rear caliper arms 404) are mounted on an uphole end of the canister 400. Thus, in some aspects, the rear calipers 404 can be communicably coupled (e.g., through the signal 406) to the alert system on the terranean surface 102. Thus, measurements from the calipers 404 during a retrieval operation can be transmitted to the alert system through the alert signal 406. The transmitted data may include numerical measurements, an alert that indicates when a measurement is less than a threshold measurement that indicates a compromised drillhole, or both. Thus, the rear calipers 404 may signal to the operator who is inserting the canister 400 that the drillhole 401 uphole of the canister 400 is not open, and the retrieval of the canister 400 should immediately be halted. In other aspects, the rear calipers 404 may be a rear support 404 that helps guide the canister 400 through the drillhole 401 (but is not communicably coupled through signal 406 to the surface).

As further shown in FIG. 4A, the single-use caliper 402 includes two calipers 402 (or two caliper arms 402), but there could be three or more caliper arms 402 to detect possible restrictions on the side of the drillhole 401 and in other directions. Further, while two rear calipers 404 are shown, there may be three or more rear calipers 404.

In some examples, the single-use caliper 402 is coupled to a detachment device attached to the canister 400 that will break off from the canister 400 if the canister 400 is pulled uphole with sufficient force, e.g., more than 100 kilograms. Thus, if the single-use caliper 402 gets jammed in the drillhole 401, the canister 400 may still be retrievable from the drillhole 401 by exerting sufficient force on the canister 400 to break the single-use caliper 402 from the canister 400. In some aspects, a length of the calipers 402 (and/or 404) in an axial direction can be small enough that the calipers 402 and/or 404 do not take a large space, so that the calipers 402 and/or 404 can be placed close to an adjacent canister 400 in the drillhole 401.

In another example implementation, the hazardous waste canister may include a jam preventer 420 attached to or with the canister 400 at or near a downhole end of the canister 400. FIG. 4B shows an example implementation of the hazardous waste canister 400 that includes a jam preventer 420 and is run into the drillhole 401 by the drillhole conveyance 127 (e.g., tubing, wirelines, wireline tractor, or otherwise). In this example, the jam preventer 420 may not measure any dimension of the drillhole 401 as the single-use caliper 402, and thus does not extend to contact the subterranean formation through which drillhole 401 is formed. The jam preventer 420, however, can be larger in dimension (e.g., diameter) than the hazardous waste canister 400. Thus, the jam preventer 420 may contact the subterranean formation at a “narrowed” location of the drillhole 401 (e.g., due to collapse or compromise of the drillhole 401) prior to such contact by the canister 400.

The jam preventer 420 may send an alert signal 406 to an operator or, e.g., to a detachable pusher connected to the conveyance 127, based on contact between the jam preventer 420 and the subterranean formation. The operator may stop insertion of the hazardous waste canister 400 based on the signal, or the detachable pusher may automatically cease operation upon such signal 406. In some examples, the jam preventer 420 is coupled to a detachment device attached to the canister 400 that can break off from the canister 400 if the canister 400 is pulled uphole with sufficient force, e.g., more than 100 kilograms.

In other example implementations, the hazardous waste canister 400 can include packer (e.g., an expandable packer or permanent expanding packer (PEP) attached to or with the canister 400 at or near a downhole end of the canister 400. FIGS. 4C and 4D show example implementations of the hazardous waste canister 400 that includes an expandable packer 430 (FIG. 4C) and PEP 440 (FIG. 4D) and is run into the drillhole 401 by the drillhole conveyance 127 (e.g., tubing, wireline, wireline tractor, or otherwise) that may or may not include a detachable pusher. The implementations shown in FIGS. 4C or 4D may also include a single-use caliper (not shown) attached to the expandable packer or PEP. Thus, a single-use caliper could function as described in FIG. 4A for the implementations of FIGS. 4C or 4D (or both).

In FIG. 4C, the expandable packer 430 (or otherwise expandable element) may act as a jam preventer as this component can be larger in diameter than the hazardous waste canister 400. Thus, the expandable packer 430 can become stuck in a drillhole constriction more easily than will the canister 400. In this configuration, once the canister 400 is in a final location in the repository, the expandable packer 430 can be expanded to provide isolation of the canister 400 from an adjacent canister in the repository. In some aspects, the expandable packer 430 is coupled to a detachment device attached to the canister 400 that will break off from the canister 400 if the canister 400 is pulled uphole with sufficient force, e.g., more than 100 kilograms. Thus, if the expandable packer 430 gets jammed in the drillhole 401, the canister 400 may still be retrievable from the drillhole 401 by exerting sufficient force on the canister 400 to break the packer 430 from the canister 400.

In FIG. 4D, the PEP 440 can be a short cylinder that serves a dual purpose of holding a single-use caliper (such as calipers 402) and placing a barrier between adjacent canisters in the drillhole 401. If the PEP 440 gets stuck, then the canister 400 can be released from the PEP 440 (e.g., by exerting sufficient pull back force on the canister 400) and pulled back to the terranean surface. The PEP 440 can then be removed with conventional fishing tools, since it contains no hazardous material. In some implementations, a curvature (e.g., a rounded downhole end) of the PEP 440 (as shown) may help prevent the PEP 440 from getting stuck on a small protrusion from the bottom that would not actually cause the canister 400, itself, to get stuck in the drillhole 401.

In example implementations of FIG. 4D, the PEP 440 can include a cylinder containing a barrier material such as bentonite. When in place at a disposal location in the repository, the PEP 440 may have small openings that would let fluid (e.g., brine) enter; then absorption of fluid by the bentonite would cause the PEP 440 to expand. The ends of the cylinder of the PEP 440 can be thick, so that the expansion can expand the thinner curved parts against the wall of the drillhole 401, or against the casing if the drillhole 401 is cased. In alternative implementations, the fluid can be contained in a separate vessel inside the PEP 440 and opened when the PEP 440 is in place with emplacement of the canister 400 in the drillhole 401. In still alternative implementations, the expansion of the PEP 440 can be performed mechanically.

In another example implementation, the hazardous waste canister 400 may include a disk-shaped jam preventer 450 attached to or with the canister at or near a downhole end of the canister 400. FIG. 4E shows the hazardous waste canister 400 that includes a disk jam preventer 450 (in cross-section) attached circumferentially around a downhole end of the canister 400. Although this example shows a circular or near circular disk jam preventer 450 (and canister 400), other example implementations may take other shapes (e.g., square). In operation, disk jam preventer 450 can contact a drillhole constriction as the canister 400 is moved downhole prior to contact between the drillhole 401 and canister 400. Thus, if the disk jam preventer 450 became stuck, the canister 400 could be removed from the drillhole 401 by decoupling the canister 400 from the disk jam preventer 450 (e.g., with enough force applied to the canister in an uphole direction, such as 100 kg). In some aspects, contact between the disk jam preventer 450 and the drillhole 401 may be detected and conveyed by the signal 406, e.g., to the terranean surface.

In another example implementation, the hazardous waste canister 400 may include a cap jam preventer 460 attached to or with the canister 400 at or near a downhole end of the canister 400. FIG. 4F shows the hazardous waste canister that includes a cap jam preventer 460 (in cross-section) attached around a downhole end of the canister 400. The cap 460 may comprise a ring with an end disk. Although this example shows a circular or near circular cap jam preventer 460 (and canister 400), other example implementations may take other shapes (e.g., square). In operation, the cap preventer 460 can contact a drillhole constriction as the canister 400 is moved downhole prior to contact between the drillhole 401 and canister 400.

The example implementation of FIG. 4F shows a cap jam preventer 460 at both a downhole and an uphole end of the canister 400. In some aspects, the uphole cap jam preventer 460 is permanently attached to the canister 400, and the downhole cap jam preventer 460 is detachably coupled to the canister 400. Thus, if the downhole cap preventer 460 became stuck, the canister 400 could be removed from the drillhole 401 by decoupling the canister 400 from the downhole cap jam preventer 460 (e.g., with enough force applied to the canister 400 in an uphole direction, such as 100 kg). In some aspects, the uphole cap jam preventer 460 can be replaced with rear calipers (such as that shown in FIGS. 4A-4E). In some aspects, contact between the downhole cap jam preventer 460 and the drillhole 401 may be detected and conveyed by the signal 406, e.g., to the terranean surface.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

A first example implementation according to the present disclosure includes a nuclear waste canister that includes a housing defining a volume sized to enclose nuclear waste and configured to store the nuclear waste in a human-unoccupiable directional drillhole formed from a terranean surface into a subterranean formation and including a substantially vertical portion and a substantially horizontal portion that includes a hazardous waste repository for nuclear waste storage, the housing including an exterior surface of the housing configured to contact a wellbore casing positioned in the horizontal portion, at least a portion of the exterior surface including an uneven surface; and a cap configured to attach to the housing to seal the nuclear waste in the volume.

In an aspect combinable with the first example implementation, the uneven surface includes a plurality of protrusions formed to contact the wellbore casing.

In another aspect combinable with any of the previous aspects of the first example implementation, each protrusion in the plurality of protrusions creates a discrete contact location between the housing and the wellbore casing.

In another aspect combinable with any of the previous aspects of the first example implementation, the contact does not produce a narrow crevice.

In another aspect combinable with any of the previous aspects of the first example implementation, each of the plurality of protrusions includes a half-sphere.

In another aspect combinable with any of the previous aspects of the first example implementation, each of the plurality of protrusions includes a half-cylinder.

The nuclear waste canister of claim 1, wherein the uneven surface includes a plurality of undulations formed to contact the wellbore casing.

In another aspect combinable with any of the previous aspects of the first example implementation, the plurality of undulations include an irregular undulating pattern.

In another aspect combinable with any of the previous aspects of the first example implementation, each undulation in the plurality of undulations creates a discrete contact location between the housing and the wellbore casing.

In another aspect combinable with any of the previous aspects of the first example implementation, the contact does not produce a narrow crevice.

In another aspect combinable with any of the previous aspects of the first example implementation, the discrete contact includes a radius of contact less than a few millimeters.

In another aspect combinable with any of the previous aspects of the first example implementation, the radius of contact is related to i) a modulus of elasticity of the uneven surface, ii) a modulus of elasticity of the wellbore casing, iii) a force between the uneven surface and the wellbore casing, iv) a radius of the uneven surface, v) a radius of the wellbore casing, vi) a Poisson ratio of the uneven surface, and vii) a Poisson ratio of the wellbore casing.

In another aspect combinable with any of the previous aspects of the first example implementation, the radius of contact is defined by an equation

$$a = \sqrt[3]{\frac{3 F [ \frac{1 - {v}_{1}^{2}}{{E}_{1}} + \frac{1 - {v}_{2}^{2}}{{E}_{2}} ]}{4 ( \frac{1}{{R}_{1}} + \frac{1}{{R}_{2}} )}} ,$$

where a is the radius of contact, v₁ is the Poisson ratio of the uneven surface, v₂ is the Poisson ratio of the wellbore casing, E₁ is the modulus of elasticity of the uneven surface, E₂ is the modulus of elasticity of the wellbore casing, R₁ is the radius of the uneven surface, R₂ is the radius of the wellbore casing, and F is the force between the uneven surface and the wellbore casing.

A second example implementation according to the present disclosure includes a casing that includes one or more tubular sections sized to fit within a human-unoccupiable directional drillhole formed from a terranean surface into a subterranean formation, the drillhole including a substantially vertical portion and a substantially horizontal portion that includes a hazardous waste repository for nuclear waste storage. At least a portion of an interior surface of the one or more tubular sections includes an uneven surface configured to contact an exterior surface of a nuclear waste canister configured to be emplaced within the casing.

In an aspect combinable with the second example implementation, the uneven surface includes a plurality of protrusions formed to contact the wellbore casing.

In another aspect combinable with any of the previous aspects of the second example implementation, each protrusion in the plurality of protrusions creates a discrete contact location between the canister and the casing.

In another aspect combinable with any of the previous aspects of the second example implementation, the contact does not produce a narrow crevice.

In another aspect combinable with any of the previous aspects of the second example implementation, each of the plurality of protrusions includes a half-sphere.

In another aspect combinable with any of the previous aspects of the second example implementation, each of the plurality of protrusions includes a half-cylinder.

In another aspect combinable with any of the previous aspects of the second example implementation, the uneven surface includes a plurality of undulations formed to contact the canister.

In another aspect combinable with any of the previous aspects of the second example implementation, the plurality of undulations include an irregular undulating pattern.

In another aspect combinable with any of the previous aspects of the second example implementation, each undulation in the plurality of undulations creates a discrete contact location between the canister and the casing.

In another aspect combinable with any of the previous aspects of the second example implementation, the contact does not produce a narrow crevice.

In another aspect combinable with any of the previous aspects of the second example implementation, the discrete contact includes a radius of contact less than a few millimeters.

In another aspect combinable with any of the previous aspects of the second example implementation, the radius of contact is related to i) a modulus of elasticity of the uneven surface, ii) a modulus of elasticity of the canister, iii) a force between the uneven surface and the canister, iv) a radius of the uneven surface, v) a radius of the canister, vi) a Poisson ratio of the uneven surface, and vii) a Poisson ratio of the canister.

In another aspect combinable with any of the previous aspects of the second example implementation, the radius of contact is defined by an equation

$$a = \sqrt[3]{\frac{3 F [ \frac{1 - {v}_{1}^{2}}{{E}_{1}} + \frac{1 - {v}_{2}^{2}}{{E}_{2}} ]}{4 ( \frac{1}{{R}_{1}} + \frac{1}{{R}_{2}} )}} ,$$

where a is the radius of contact, v₁ is the Poisson ratio of the uneven surface, v₂ is the Poisson ratio of the canister, E₁ is the modulus of elasticity of the uneven surface, E₂ is the modulus of elasticity of the canister, R₁ is the radius of the uneven surface, R₂ is the radius of the canister, and F is the force between the uneven surface and the canister.

A third example implementation according to the present disclosure includes a method of storing nuclear waste that includes placing a nuclear waste canister that encloses nuclear waste in a hazardous waste repository of a human-unoccupiable directional drillhole formed from a terranean surface into a subterranean formation, the drillhole including a vertical portion and a horizontal portion that includes the hazardous waste repository, the horizontal portion including a casing formed from one or more tubular sections; contacting, by placing, either (i) an uneven surface of an exterior surface of the nuclear waste canister with an interior surface of the casing; or (ii) an uneven surface of the interior surface of the casing with the exterior surface of the nuclear waste canister; and based on the contacting, creating discrete contact locations between the exterior surface of the nuclear waste canister and the interior surface of the casing.

In an aspect combinable with the third example implementation, the uneven surface includes a plurality of protrusions.

In another aspect combinable with any of the previous aspects of the third example implementation, each protrusion in the plurality of protrusions creates an individual, discrete contact location between the canister and the casing.

In another aspect combinable with any of the previous aspects of the third example implementation, the contact does not produce a narrow crevice.

In another aspect combinable with any of the previous aspects of the third example implementation, each of the plurality of protrusions includes a half-sphere.

In another aspect combinable with any of the previous aspects of the third example implementation, each of the plurality of protrusions includes a half-cylinder.

In another aspect combinable with any of the previous aspects of the third example implementation, the uneven surface includes a plurality of undulations.

In another aspect combinable with any of the previous aspects of the third example implementation, the plurality of undulations include an irregular undulating pattern.

In another aspect combinable with any of the previous aspects of the third example implementation, each undulation in the plurality of undulations creates an individual, discrete contact location between the canister and the casing.

In another aspect combinable with any of the previous aspects of the third example implementation, the contact does not produce a narrow crevice.

In another aspect combinable with any of the previous aspects of the third example implementation, the discrete contact includes a radius of contact less than a few millimeters.

In another aspect combinable with any of the previous aspects of the third example implementation, the radius of contact is related to i) a modulus of elasticity of the uneven surface, ii) a modulus of elasticity of the canister, iii) a force between the uneven surface and the canister, iv) a radius of the uneven surface, v) a radius of the canister, vi) a Poisson ratio of the uneven surface, and vii) a Poisson ratio of the canister.

In another aspect combinable with any of the previous aspects of the third example implementation, the radius of contact is defined by an equation

$$a = \sqrt[3]{\frac{3 F [ \frac{1 - {v}_{1}^{2}}{{E}_{1}} + \frac{1 - {v}_{2}^{2}}{{E}_{2}} ]}{4 ( \frac{1}{{R}_{1}} + \frac{1}{{R}_{2}} )}} ,$$

where a is the radius of contact, v₁ is the Poisson ratio of the uneven surface, v₂ is the Poisson ratio of the canister, E₁ is the modulus of elasticity of the uneven surface, E₂ is the modulus of elasticity of the canister, R₁ is the radius of the uneven surface, R₂ is the radius of the canister, and F is the force between the uneven surface and the canister.

A fourth example implementation according to the present disclosure includes a nuclear waste canister that includes a bottom housing portion; a top housing portion; and a side housing portion attached to the bottom and top housing portions to define an inner volume sized to enclose nuclear waste and configured to store the nuclear waste in a hazardous waste repository of a human-unoccupiable directional drillhole formed in a subterranean formation, at least one of the top housing portion or the side housing portion including an exterior surface configured to attach to a downhole retrieval device.

In an aspect combinable with the fourth example implementation, the exterior surface includes a plurality of ridges configured to facilitate an attachment to the retrieval device.

In another aspect combinable with any of the previous aspects of the fourth example implementation, each ridge of the plurality of ridges includes a square cross-section or a semi-circle cross-section.

In another aspect combinable with any of the previous aspects of the fourth example implementation, each ridge of the plurality of ridges circumscribes the exterior surface.

In another aspect combinable with any of the previous aspects of the fourth example implementation, each ridge of the plurality of ridges includes a small isolated bump.

In another aspect combinable with any of the previous aspects of the fourth example implementation, each ridge of the plurality of ridges forms a spiral around the exterior surface.

In another aspect combinable with any of the previous aspects of the fourth example implementation, each spiral is configured to match a spiral of an interior surface of the retrieval device such that when twisted around an axis of the housing, the retrieval device screws onto the housing.

In another aspect combinable with any of the previous aspects of the fourth example implementation, the exterior surface is roughened.

A fifth example implementation according to the present disclosure includes a method of retrieving a nuclear waste canister that includes lowering a retrieval device into a human-unoccupiable drillhole toward a nuclear waste canister positioned in a hazardous waste repository formed in a subterranean formation into which the drillhole is formed. The nuclear waste canister includes a bottom housing portion, a top housing portion, and a side housing portion attached to the bottom and top housing portions to define an inner volume sized to enclose and store nuclear waste and configured to store the nuclear waste. The method further includes attaching the retrieval device to an at least one of the top housing portion or the side housing portion that includes an exterior surface configured to attach to the retrieval device; and retrieving the retrieval device attached to the nuclear waste canister in the drillhole toward a terranean surface.

In an aspect combinable with the fifth example implementation, the exterior surface includes a plurality of ridges configured to facilitate an attachment to the retrieval device.

In another aspect combinable with any of the previous aspects of the fifth example implementation, the each ridge of the plurality of ridges includes a square cross-section or a semi-circle cross-section.

In another aspect combinable with any of the previous aspects of the fifth example implementation, each ridge of the plurality of ridges circumscribes the exterior surface.

In another aspect combinable with any of the previous aspects of the fifth example implementation, each ridge of the plurality of ridges includes a small isolated bump.

In another aspect combinable with any of the previous aspects of the fifth example implementation, each ridge of the plurality of ridges forms a spiral around the exterior surface.

In another aspect combinable with any of the previous aspects of the fifth example implementation, each spiral is configured to match a spiral of an interior surface of the retrieval device, the method further including screwing the retrieval device onto the housing.

In another aspect combinable with any of the previous aspects of the fifth example implementation, the exterior surface is roughened.

A sixth example implementation according to the present disclosure includes a nuclear waste canister that includes a bottom housing portion; a top housing portion; and a side housing portion attached to the bottom and top housing portions to define an inner volume sized to enclose nuclear waste and configured to store the nuclear waste in a hazardous waste repository of a human-unoccupiable directional drillhole formed in a subterranean formation. The canister further includes a knob assembly including a post attached to the top housing portion and a knob attached to the post and configured to couple to a downhole fishing tool; and an outer lip that extends from the top housing portion and is angled toward an axial centerline of the side housing portion.

In an aspect combinable with the sixth example implementation, the outer lip includes a cylindrical portion attached to the top housing portion and extending away from the top housing portion.

In another aspect combinable with any of the previous aspects of the sixth example implementation, the post includes an inner lip angled toward the cylindrical portion.

In another aspect combinable with any of the previous aspects of the sixth example implementation, the top housing portion includes a diameter that is the same as a diameter of the side housing portion.

In another aspect combinable with any of the previous aspects of the sixth example implementation, at least one of the outer lip or the inner lip is shaped to secure to a hook.

In another aspect combinable with any of the previous aspects of the sixth example implementation, at least one of the outer lip and the inner lip includes at least one of alloy 22 or alloy 625.

In another aspect combinable with any of the previous aspects of the sixth example implementation, the canister further includes a filler material positioned on the top housing portion and adjacent the outer lip.

In another aspect combinable with any of the previous aspects of the sixth example implementation, the filler material forms a liquid seal within an open space between the outer lip and the post.

In another aspect combinable with any of the previous aspects of the sixth example implementation, the filler material includes a semi-solid material.

In another aspect combinable with any of the previous aspects of the sixth example implementation, the semi-solid material includes aerogel.

A seventh example implementation according to the present disclosure includes a method for retrieving a nuclear waste canister that includes running a retrieval tool into a human-unoccupiable directional drillhole in a subterranean formation beneath a terranean surface that stores nuclear waste in a nuclear waste canister that includes a bottom housing portion; a top housing portion; a side housing portion attached to the bottom and top housing portions to define an inner volume sized to enclose the nuclear waste; a knob assembly including a post attached to the top housing portion and a knob attached to the post and configured to couple to a downhole fishing tool; and an outer lip that extends from the top housing portion and is angled toward an axial centerline of the side housing portion. The method further includes attaching the retrieval tool to the outer lip of the nuclear waste canister; and lifting the nuclear waste canister out of the drillhole with the retrieval tool.

In an aspect combinable with the seventh example implementation, the outer lip includes a cylindrical portion attached to the top housing portion and extending away from the top housing portion.

In another aspect combinable with any of the previous aspects of the seventh example implementation, the post includes an inner lip angled toward the cylindrical portion.

In another aspect combinable with any of the previous aspects of the seventh example implementation, the top housing portion includes a diameter that is the same as a diameter of the side housing portion.

In another aspect combinable with any of the previous aspects of the seventh example implementation, at least one of the outer lip or the inner lip is shaped to secure to a hook of the retrieval tool.

In another aspect combinable with any of the previous aspects of the seventh example implementation, at least one of the outer lip and the inner lip includes at least one of alloy 22 or alloy 625.

In another aspect combinable with any of the previous aspects of the seventh example implementation, the method further includes inserting the retrieval tool through at least a portion of a filler material positioned on the top housing portion and adjacent the outer lip to attach to the outer lip.

In another aspect combinable with any of the previous aspects of the seventh example implementation, the filler material forms a liquid seal within an open space between the outer lip and the post.

In another aspect combinable with any of the previous aspects of the seventh example implementation, the filler material includes a semi-solid material.

In another aspect combinable with any of the previous aspects of the seventh example implementation, the semi-solid material includes aerogel.

An eighth example implementation according to the present disclosure includes a hazardous waste canister that includes a housing that defines an inner volume sized to enclose a portion of hazardous waste and configured to store the hazardous waste in a human-unoccupiable directional drillhole formed from a terranean surface into a subterranean formation that includes a hazardous waste repository; a coupling attached at or near a first end of the housing and configured to couple to a downhole conveyance; and a jam preventer coupled at or near a second end of the housing, the jam preventer including a protrusion that extends beyond a cross-sectional radial or diagonal dimension of an exterior surface of the housing.

In an aspect combinable with the eighth example implementation, the jam preventer includes a disk jam preventer that circumscribes the exterior surface of the housing at or near the second end of the housing.

In another aspect combinable with any of the previous aspects of the eighth example implementation, the protrusion includes a radial edge of the disk jam preventer.

In another aspect combinable with any of the previous aspects of the eighth example implementation, the jam preventer includes a cap jam preventer that circumscribes the exterior surface of the housing around the second end of the housing.

In another aspect combinable with any of the previous aspects of the eighth example implementation, the protrusion includes a radial edge or end cap of the cap jam preventer.

In another aspect combinable with any of the previous aspects of the eighth example implementation, the jam preventer includes an expandable packer attached at the second end of the housing.

In another aspect combinable with any of the previous aspects of the eighth example implementation, the expandable packer includes a permanent expanding packer (PEP).

In another aspect combinable with any of the previous aspects of the eighth example implementation, the protrusion includes a rounded portion of the PEP.

In another aspect combinable with any of the previous aspects of the eighth example implementation, the jam preventer includes one or more calipers.

In another aspect combinable with any of the previous aspects of the eighth example implementation, the one or more calipers include a single-use caliper.

In another aspect combinable with any of the previous aspects of the eighth example implementation, the one or more calipers are configured to measure a dimension of the directional drillhole.

In another aspect combinable with any of the previous aspects of the eighth example implementation, the dimension includes a diameter.

In another aspect combinable with any of the previous aspects of the eighth example implementation, the one or more calipers are configured to periodically measure the dimension of the directional drillhole.

In another aspect combinable with any of the previous aspects of the eighth example implementation, the one or more calipers are communicably coupled to an alert control system to provide the measurement through a wired or wireless connection to the alert control system.

In another aspect combinable with any of the previous aspects of the eighth example implementation, the alert control system is at or near the terranean surface.

In another aspect combinable with any of the previous aspects of the eighth example implementation, the hazardous waste includes nuclear waste.

In another aspect combinable with any of the previous aspects of the eighth example implementation, the nuclear waste includes high level waste or spent nuclear fuel.

In another aspect combinable with any of the previous aspects of the eighth example implementation, the directional drillhole includes an open hole directional drillhole.

A ninth example implementation according to the present disclosure includes a method of moving a hazardous waste canister to a hazardous waste repository that includes coupling a hazardous waste canister to a downhole conveyance, the canister including a housing that defines an inner volume sized to enclose a portion of hazardous waste and a jam preventer coupled to a downhole end of the housing, the jam preventer including a protrusion that extends beyond a cross-sectional radial or diagonal dimension of an exterior surface of the housing; moving the hazardous waste canister through a human-unoccupiable directional drillhole formed from a terranean surface into a subterranean formation that includes a hazardous waste repository; and detecting, with the jam preventer, contact of the protrusion with a constriction of the directional drillhole.

In an aspect combinable with the ninth example implementation, the jam preventer includes a disk jam preventer that circumscribes the exterior surface of the housing at or near the second end of the housing.

In another aspect combinable with any of the previous aspects of the ninth example implementation, the protrusion includes a radial edge of the disk jam preventer.

In another aspect combinable with any of the previous aspects of the ninth example implementation, the jam preventer includes a cap jam preventer that circumscribes the exterior surface of the housing around the second end of the housing.

In another aspect combinable with any of the previous aspects of the ninth example implementation, the protrusion includes a radial edge or end cap of the cap jam preventer.

In another aspect combinable with any of the previous aspects of the ninth example implementation, the jam preventer includes an expandable packer attached at the second end of the housing.

In another aspect combinable with any of the previous aspects of the ninth example implementation, the expandable packer includes a permanent expanding packer (PEP).

In another aspect combinable with any of the previous aspects of the ninth example implementation, the protrusion includes a rounded portion of the PEP.

In another aspect combinable with any of the previous aspects of the ninth example implementation, the jam preventer includes one or more calipers.

In another aspect combinable with any of the previous aspects of the ninth example implementation, the one or more calipers include a single-use caliper.

In another aspect combinable with any of the previous aspects of the ninth example implementation, the method further includes measuring a dimension of the directional drillhole with the one or more calipers during the moving.

In another aspect combinable with any of the previous aspects of the ninth example implementation, the dimension includes a diameter.

In another aspect combinable with any of the previous aspects of the ninth example implementation, the method further includes periodically measuring the dimension of the directional drillhole with the one or more calipers during the moving.

In another aspect combinable with any of the previous aspects of the ninth example implementation, the method further includes providing the measurement through a wired or wireless connection to an alert control system communicably coupled to the one or more calipers.

In another aspect combinable with any of the previous aspects of the ninth example implementation, the alert control system is at or near the terranean surface.

In another aspect combinable with any of the previous aspects of the ninth example implementation, the hazardous waste includes nuclear waste.

In another aspect combinable with any of the previous aspects of the ninth example implementation, the nuclear waste includes high level waste or spent nuclear fuel.

In another aspect combinable with any of the previous aspects of the ninth example implementation, the directional drillhole includes an open hole directional drillhole.

A number of implementations have been described. Nevertheless, it will be understood that various modifications may be made without departing from the spirit and scope of the disclosure. For example, while many example implementations of a hazardous material canister according to the present disclosure include a cross-section that is circular or oval, other shapes are contemplated, such as square or rectangular. Also, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A method for storing nuclear waste, comprising:
positioning a casing at an entry of a human-unoccupiable directional drillhole formed from a terranean surface to a subterranean formation, the casing comprising a coating attached to an exterior surface of the casing, the casing comprising one or more tubular sections sized to fit within the human-unoccupiable directional drillhole, the drillhole comprising a substantially vertical portion and a substantially horizontal portion that comprises a hazardous waste repository for nuclear waste storage;
inserting the casing into the drillhole such that the exterior surface of the casing faces a rock formation through which the drillhole is formed;
moving a nuclear waste canister into the drillhole through the casing, the nuclear waste canister configured to hold nuclear waste; and
storing the nuclear waste canister in the hazardous waste repository.

2. The method of claim 1, wherein the casing comprises carbon-steel.

3. The method of claim 1, wherein the coating comprises a corrosion-resistant and scratch-resistant coating.

4. The method of claim 3, wherein the coating comprises at least one of quartz, diamond-like carbon (DLC), hard chrome, high velocity oxygen fuel (HVOF), Hardide®, or other glasses.

5. The method of claim 1, further comprising attaching another coating to an interior surface of the casing.

6. The method of claim 5, wherein the another coating comprises at least one of a corrosion resistant alloy (CRA) or stainless steel.

7. The method of claim 5, wherein the another coating comprises a corrosion-resistant and scratch-resistant coating.

8. The method of claim 7, wherein the another coating comprises at least one of quartz or DLC.

9. The method of claim 1, wherein the nuclear waste canister is configured to be retrievable from the drillhole at any time within a period of time.

10. The method of claim 9, wherein the period of time is set as an industry requirement in order to use the drillhole as an interim storage facility.

11. The method of claim 9, wherein the period of time ranges from a few years to up to 50 years.

12. The method of claim 1, further comprising sealing the substantially vertical portion of the drillhole to transform the hazardous waste repository into a permanent hazardous waste repository.

13. A nuclear waste storage system, comprising:
a human-unoccupiable directional drillhole formed from a terranean surface into a subterranean formation, the drillhole comprising a substantially vertical portion and a substantially horizontal portion that comprises a hazardous waste repository for nuclear waste storage;
a casing comprising one or more tubular sections sized to fit within the drillhole; and
a coating attached to an exterior surface of the casing, the exterior surface facing a rock surface of the subterranean formation through which the drillhole is formed.

14. The storage system of claim 13, further comprising a nuclear waste canister configured to store nuclear waste and positioned in the hazardous waste repository.

15. The storage system of claim 13, wherein the casing comprises carbon-steel.

16. The storage system of claim 13, wherein the coating comprises a corrosion-resistant and scratch-resistant coating.

17. The storage system of claim 16, wherein the coating comprises at least one of quartz, diamond-like carbon (DLC), hard chrome, high velocity oxygen fuel (HVOF), Hardide®, or other glasses.

18. The storage system of claim 13, further comprising another coating attached to an interior surface of the casing.

19. The storage system of claim 18, wherein the another coating comprises at least one of a corrosion resistant alloy (CRA) or stainless steel.

20. The storage system of claim 18, wherein the another coating comprises a corrosion-resistant and scratch-resistant coating.

21. The storage system of claim 20, wherein the another coating comprises at least one of quartz or DLC.

22. The storage system of claim 13, wherein the nuclear waste canister is configured to be retrievable from the drillhole at any time for a period of time.

23. The storage system of claim 22, wherein the period of time is set as an industry requirement in order to use the drillhole as an interim storage facility.

24. The storage system of claim 22, wherein the period of time ranges from a few years to up to 50 years.

25. The storage system of claim 13, further comprising a plug positioned to seal the substantially vertical portion of the drillhole to transform the hazardous waste repository into a permanent hazardous waste repository.
